(19) United States
(12) Patent Application Publication
(10) Pub. No.: US 2004/0094370 A1
(43) Pub. Date: May 20, 2004

(54) Lift cage, lift with the lift cag and method of assembling the lift

(76) Inventors: Esben Rotboll, Zug (CH); Christoph Liebetrau, Menziken (CH)

Correspondence Address: Jay A. Bondell, Esq., SCHWEITZER CORNMAN GROSS & BONDELL LLP, 292 Madison Avenue, New York, NY, 10017, US

(21) Appl. No.: 10/644,188

(22) Filed: Aug. 20, 2003

(30) Foreign Application Priority Data
Aug. 29, 2002 (EP) 02405737.4

(51) Int. Cl. B66B 11/02

(52) U.S. Cl. 187/401

(57) ABSTRACT

The invention relates to a lift cage, a lift with the lift cage and a method of assembling the lift. The lift cage comprises a three-dimensional body for receiving persons or articles to be conveyed and has a support body for accepting all forces acting on the three-dimensional body during the conveying of the persons or articles. The three-dimensional body is suspended in the support body. The support body comprises two side frames which are connected together by way of at least one top frame in moment-stiff manner.

The present invention relates to a lift cage, a lift with the lift cage and a method of assembling the lift.

### BACKGROUND OF THE INVENTION

A lift cage with a base frame to which two side frames are laterally attached at the left and the right is known from EP 0 972 738. A space for the persons or articles to be conveyed is enclosed by a thin-walled shell and forms a three-dimensional body. The three-dimensional body is seated on the base frame. The base frame is required in order to impart sufficient stiffness to the lift cage. The forces acting during conveying of persons or articles are conducted from the three-dimensional body by way of the base frame into the two side frames and from there into guide rails.

A disadvantage of the lift cage is a required less compact size thereof in the floor region.

A first object of the present invention is to create a lift cage which has more compact dimensions, particularly in the floor region, and thus has a high degree of stiffness. A further object of the invention is to allow a lift cage to be assembled in a simple, quick and uncomplicated manner. It is also an object of the invention to provide a lift cage and lift with low production costs, thus controlling the costs of the entire building in which the lift is mounted.

### BRIEF DESCRIPTION OF THE INVENTION

The foregoing and other objects are fulfilled by a lift cage of the present invention having a three-dimensional body for receiving persons or articles to be conveyed and a support body for receiving all forces acting on the three-dimensional body. The three-dimensional body is supported within the support body.

The area and volume requirement of a lift cage of a lift mounted in a building is minimized by the invention. Taking into consideration the entire area and volume available for the lift, the volume requirement below the cage floor is minimized.

The floor depth of the lift cage is defined as the thickness of the lift cage between the cage floor for the persons or articles which are to be conveyed in the interior of the lift cage and the deepest point of the lift cage.

The region of the lift shaft where the shaft pit in its depth penetrates a floor plate of the building is termed the shaft pit. An especially deep shaft pit causes additional costs, since provisions have to be made for formation of the shaft pit in the floor plate of the shell of the building. These additional costs affect both the construction and the realization of the floor plate.

According to the invention a functional separation of the lift cage into a three-dimensional body and a support body is implemented. The three-dimensional body receives the persons or articles to be conveyed. The support body receives all forces acting on the three-dimensional body during conveyance of the persons or articles.

The three-dimensional body itself is hardly able to be optimized and substantially consists of a space for the persons or articles to be conveyed, surrounded by a thin-walled shell. Advantageously, the three-dimensional body consists of at least one floor member, at least one wall member and at least one roof member. The lower end of the three-dimensional body, facing the floor plate of the building, is defined as the floor member. The upper end of the three-dimensional body, facing away from the floor plate of the building, is defined as the roof member. The wall members lie between the floor member and roof member. An upper side of the floor member advantageously forms the cage floor of the lift cage. Advantageously the mechanical structure of the three-dimensional body is reinforced by at least one structural member.

The support body advantageously comprises at least one top frame and at least two side frames, which accept all forces acting during conveyance of the persons or articles. Guide means and a safety brake device can be fastened in a space-saving manner to the side frames, whereby the forces to be eliminated are conducted highly efficiently into the guide rails. Advantageously, the top frame is connected to an upper end of each guide frame in a moment-stiff manner. The end of the side frame remote from the floor plate of the building is defined as the upper end of the side frame.

In an advantageous embodiment of the invention the three-dimensional body is suspended at the top frame of the lift cage. Advantageously, the three-dimensional body is suspended in the support body like a gallows. Suspension of the three-dimensional body in the support body is by a shape-locking and/or force-locking fastening by way of which all forces acting on the three-dimensional body during conveying of the persons or articles are conducted into the support body. In contrast to the state of the art, a base frame is thus superfluous. Advantageously, the lift frame does not have any base frame and thus has a minimal floor depth of the thickness of the floor member. Frame members requiring constructional space thus do not extend under the three-dimensional body. The mounting of such a lift shaft is simple in terms of function separation and takes place quickly.

### BRIEF DESCRIPTION OF THE DRAWINGS

The invention is explained in detail in the following by reference to FIGS. 1 and 2, in which:

FIG. 1 is an exploded perspective view of a part of a lift cage embodying the invention; and

FIG. 2 is a schematic view of a lift with a lift cage according to FIG. 1.

### DETAILED DESCRIPTION OF THE INVENTION

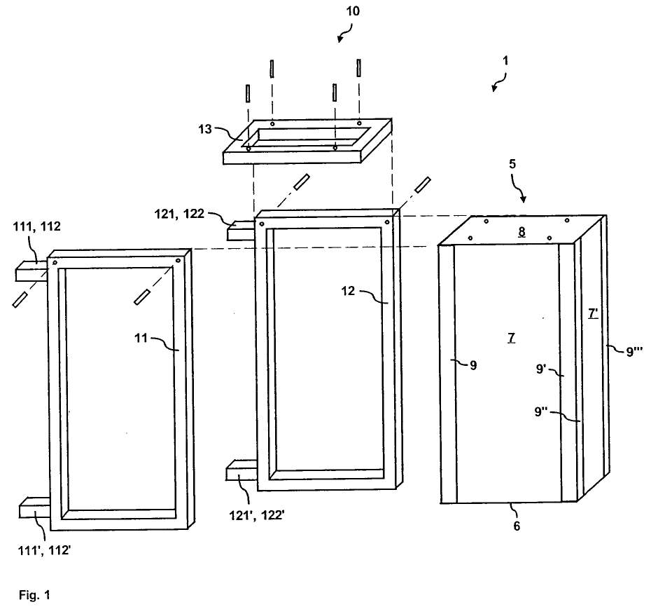

FIG. 1 shows, as an exploded illustration, a part of a lift cage 1. The lift cage 1 consists of a three-dimensional body 5 and a support body 10. The three-dimensional body 5 receives the persons or articles to be conveyed. The support body 10 accepts all forces acting during conveyance of the persons or articles. The three-dimensional body 5 is arranged within the support body 10. Advantageously, the three-dimensional body 5 is merely suspended in the support body 10. Frame parts requiring constructional space do not extend under the three-dimensional body 5.

The three-dimensional body 5 substantially consists of a space for the persons or articles to be conveyed. This space is enclosed by a thin-walled shell. Advantageously, the three-dimensional body 5 consists of at least one floor member 6, at least one wall member 7, 7′ and at least one roof member 8. One wall member is designed as at least one cage door, by way of which persons or articles have access to the space. Advantageously, the floor member 6 is of integral and rigid construction so that the persons or articles to be conveyed can stand thereupon.

The three-dimensional body 5 may comprise optional structural members 9, 9′, 9″, 9′″. These reinforce the mechanical structure of the three-dimensional body 5 and serve the purpose of conducting all forces which act on the three-dimensional body 5 during conveyance of the persons or articles as tension forces from the floor member 6 to the roof member 8. Advantageously, at least one structural member 9, 9″, 9′, 9″′ may be constructed as a flat profile element which is externally mounted at the three-dimensional body 5 and which mechanically connects the floor member 6 and the roof member 8 together. Obviously the structural members 9, 9′, 9″, 9′″ can also be mounted in the interior of the three-dimensional body 5. Advantageously, the structural members 9, 9′, 9″, 9″′ are arranged in the region of the edges and corners of the three-dimensional body 5. Such structural members 9, 9′, 9″, 9′″ can be designed to be very flat and thus require only minimum space. Advantageously, the three-dimensional body 5 consisting of floor member 6, wall members 7, 7′, roof member 8 and structural members 9, 9′, 9″, 9′″ is arranged substantially entirely in the support body 10 and does not project out of an envelope of the support body 10. Advantageously, the three-dimensional body 5 is made of standardized and prefabricated elements, for example of profile elements. With knowledge of the present invention one skilled in the art has available numerous variations of realization of a structural member. Thus, it is possible to design the structural members as a strap or a cable, which structural members enclose the three-dimensional body at least regionally.

The support body 10 comprises at least one top frame 13 and two side frames 11, 12. The top frame 13 is advantageously connected to the two side frames 11, 12 in a moment-stiff manner. The side frames have upper and lower ends. The end of the side frame remote from the floor plate of the building is defined as upper end of the side frame. The lower ends are oriented towards the floor plate of the building. Advantageously, the top frame 13 is arranged between the first side frame 11 and the second side frame 12. The top frame 13 is connected with to a respective upper end of each side frame 11, 12 and connects the two side frames 11, 12 by way of these upper ends. Advantageously, the top frame 13 and the side frames 11, 12 are standardized and prefabricated elements, for example profile elements. The profile elements consist of, for example, substantially U-shaped sheet metal profile sections, each with a large number of assembly bores. The preformed assembly bores enable application, during assembly of the lift cage 1, of further elements without reprocessing of the sheet metal profile sections at the construction site.

It is possible to mount further reinforcing elements to the support body 10. Thus, at least one cross member or at least one beam can be mounted at the support body 10. A reinforcing element connecting the top frame 13 with a side frame 11, 12 is defined as a cross member. An element reinforcing the top frame 13 or a side frame 11, 12 is defined as a beam. A base frame, which is optional and non-essential in the sense of the invention, can be mounted at a lower end of each side frame 11, 12 and can thus connect the two side frames 11, 12 at the lower ends thereof in torsionally stiff manner.

Advantageously the top frame 13 comprises at least one fastening means for suspension of the three-dimensional body 5. The fastening means can be designed in any desired manner, for example the fastening means may consist of a screw connection. Advantageously, the three-dimensional body 5 is suspended directly in the top frame 13. Advantageously, the three-dimensional body 5 is suspended in the top frame 13 by way of the roof member 8 and/or the structural member 9, 9′, 9″, 9′41 . In this manner the top frame 13 can pass on all forces which act on the suspended three-dimensional body 5 during conveying of persons or articles as tension forces to the two side frames 11, 12. With knowledge of the present invention, numerous variations for suspension of a three-dimensional body in a support body are available to one skilled in the art. Thus, it is possible, for additional suspension in the top frame 13, to also suspend the three-dimensional body from one of the two side frames 11, 12. At least one intermediate member can optionally be mounted between the roof member 8 and the top frame 13. Such an intermediate member damps, for example, vibrations or solid-borne sound between the three-dimensional body 5 and the support body 10, such vibrations or sound being perceived as unpleasant by the persons to be conveyed or being disadvantageous for the articles to be conveyed.

The side frames 11, 12, pass on the forces which act on the top frame 13 during conveyance of persons or articles by the suspended three-dimensional body 5 to at least one guide rail. Advantageously, each of the side frames 11, 12 is guided along a guide rail by way of at least one guide shoe 111, 121. In addition, each side frame 11, 12 has a safety-brake device 112, 122.

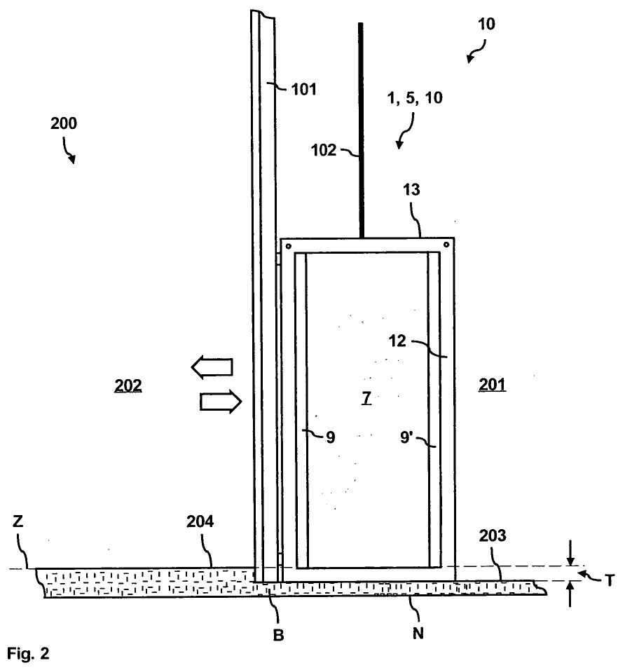

FIG. 2 schematically shows a part of a lift 100 with a lift cage 1 according to FIG. 1. Advantageously, the lift cage 1 is connected with at least one guide rail 101 by way of the side frames 11, 12. The guide rail 101 is mounted in known manner in or at a building 200. Advantageously the guide rail 101 is mounted as a vertical guide rail in a lift shaft 201. The lift shaft 201 is a building component which extends in a chimney-like manner and without interruption from a lowermost to an uppermost storey of the building 200. The lift cage 1 is moved by a drive by way of a conveying cable 102. Advantageously the drive is arranged in an upper region of the lift shaft 201. For example, the conveying cable 102 is fastened to the top frame 13. The conveying cable 102 and the drive are a conveying cable drive and drive conventionally used in lift engineering. The lift 100 does not have to be mounted in the interior of the building 200 in a lift shaft 201, but can also be mounted outside the building 200. Numerous possibilities of variation with respect thereto are available to one skilled in the art.

In the view according to FIG. 2, the lift cage 1 is disposed at a lowermost storey 202 of the building 200. The lowermost storey 202 directly adjoins the floor plate B of the building 200. The floor plate B consists of, for example, concrete and forms the base, i.e. the lowermost point, of the building 200. The upper side of the base plate B is constructed in the region of the lowermost storey 202 as a storey floor 204 and in the region of the lift shaft 201 as a lift shaft base 203. The underside of the floor plate B lies in the region of the lowermost storey 202 and in the region of the lift shaft base 203 at a level N.

The persons or articles to be conveyed have access to the lift cage 1. In the form of embodiment of a lift 100 according to FIG. 2 this access of the persons or articles to be conveyed is schematically illustrated by an embarkation arrow and by a disembarkation arrow. The access of the persons or articles to be conveyed takes place at an access level Z of the storey floor 204. It is prerequisite for safe access of the persons or articles to be conveyed that the storey floor 204 and the cage floor lie at the same access level Z. The cage floor is preferably formed by an upper side of the floor member 6 of the three-dimensional body 5.

In order to fulfill the condition of safe access of the persons or articles to be conveyed, the lift cage 1 has to be moved by the amount of the floor depth T thereof below the level of the storey floor 204. The floor depth T of the lift cage 1 equals the sum of a thickness of the floor member 6 and a thickness of an optional base frame. In the form of embodiment of a lift according to FIG. 2, the storey floor 204 and the lift shaft base 203 are disposed at different levels due to the floor depth T of the lift cage 1. Advantageously, the floor depth T of the lift cage 1 is minimal, and corresponds to the thickness of the floor member 6. As a minimum floor depth T is thus defined, a specially deep shaft pit, in which the lift shaft base 203 extends below the floor plate B, does not have to be formed. Accordingly, the underside of the floor plate B in the region of the lowermost storey 202 and the lift shaft 201 lies at the same level N.

The components of the lift cage 1 are made at least partly of metal or plastics material. Preferably the components of the lift cage 1 are made of sheet steel of suitable thickness and quality. However, light metals can also be provided for the purpose of weight reduction. The connections of the components of the lift cage 1 take place by way of known force-locking, material-bonding or shape-locking means. Preferably, the components of the lift cage 1 are detachably connected together. For example, the components of the lift cage 1 are screw-connected or riveted together. In addition, the components of the lift cage 1 are of sufficient size to allow assembly bores to be formed. The components of the lift cage 1 are so dimensioned with respect to stiffness and strength that they serve as rigid brackets for fittings and mechanical subassemblies, as well as for electrical functional groups such as a door drive, door guide, door threshold, apron, storey indicator, call buttons, lighting, decorative elements, inspection panel, etc., to be fastened thereto. In a preferred form of embodiment the lift cage 1 is constructed as a ‘rucksack’ cage with lateral access.

For mounting of the lift 100 in the lift shaft 201 of the building 200 the three-dimensional body 5 is suspended in the support body 10. Advantageously this mounting is carried out in several method steps:

In a first method step the at least one guide rail 101 is mounted in the lift shaft 201, the drive of the lift 100 is mounted in the engine room and a conveying cable 102 is fastened to the drive.

In a second method step the side frames 11, 12 are connected with the top frame 13 in a torsionally stiff manner to form the support body 10. Advantageously, the side frames 11, 12 are positioned on the lift shaft base 203. In this position the side frames 11, 12 are disposed parallel to one another at a spacing from the width of the top frame 13 and each of the side frames 11, 12 bears against the guide rail 101 by way of at least one guide shoe 111, 121. The top frame 13 is fastened to the conveying cable 102 and is raised by the drive to a fastening level between the side frames 11, 12. In this position the top frame 13 is connected to the side frames 11, 12.

In a third method step the roof member 8 and/or the structural members 9, 9′, 9″, 9′″ are suspended from the top frame 13 or at least one side frame 11, 12. The wall members 7, 7′ and the floor member 6 are attached to the suspended roof member 8 or to the suspended structural members 9, 9′, 9″, 9′″. The elements of roof member 8 and structural member 9, 9′, 9″, 9′″, wall member 7, 7′ and floor member 6 are connected together to form the three-dimensional body 5. Fillings, mechanical subassemblies and electrical functional groups are then installed at the lift cage 1.

With knowledge of the present invention, numerous possibilities of variation of assembly of a lift are available. For example, it is possible to suspend a three-dimensional body 5 at the top frame 13 only by way of the roof member 8, thereupon to then attach the wall member 7, 7′ and the floor member 6, and finally to reinforce and stiffen this construction by the structural member 9, 9′, 9″, 9′″. It is possible, for example, to connect the wall member 7, 7′ or the floor member 6 with the side frames 11, 12. Finally, it is possible to mount a base frame at the side frames 11, 12 and/or at the floor member 6.

We claim:

1. A lift cage comprising a three-dimensional body for receiving persons or articles to be conveyed and suspended in a support body for accepting all forces arising during conveying of the persons or articles, the three-dimensional body comprising at least one floor member, the lift cage having a floor depth corresponding to the a thickness of the floor member.

2. The lift cage according to claim 1, wherein the support body comprises two side frames which are connected together by way of at least one top frame in moment-stiff manner.

3. The lift cage according to claim 1 or 2, wherein the three-dimensional body comprises at least one floor member, at least one wall member and at least one roof member.

4. The lift cage according to claim 3, wherein the three-dimensional body comprises at least one structural member.

5. The lift cage according to claim 4, wherein the structural member is a flat profile element.

6. The lift cage according to claim 4, wherein the structural member is mounted outside the three-dimensional body.

7. The lift cage according to claim 4, wherein the structural member mechanically connects the floor member and the roof member together.

8. The lift cage according to claim 4, wherein the three-dimensional body is suspended in the support body by way of the structural member.

9. The lift cage according to claim 4, wherein the three-dimensional body is suspended in the support body by way of the roof member.

10. A lift with at least one lift cage comprising a three-dimensional body for receiving persons or articles to be conveyed and of a support body for accepting all forces arising during conveying of the persons or articles; a lift shaft in which the lift is moved; and a lift shaft base lying above an underside of a lift shaft floor plate.

11. The lift cage according to claim 10, wherein the lift shaft is in a building having a lowermost story region, the lift shaft base and the underside of the floor plate lying at the same level at the lowermost story region.

12. A method of mounting a lift cage in a lift shaft, which lift cage comprises a three-dimensional cage for receiving persons or articles to be conveyed and a support body for accepting all forces arising during conveying of the persons or articles, the three-dimensional body comprising at least one floor member, comprising the steps of positioning the support body in the lift shaft; raising the support body; and suspending the three-dimensional body from the support body.

13. The method according to claim 12, wherein the positioning step comprises the positioning of at least two side frames of the support body on a lift shaft base, wherein the side frames are disposed parallel to one another at a spacing of a width of a top frame of the support body and each side frame bears by way of at least one guide shoe along a guide rail located with the lift shaft; fastenings of a top frame to a conveying cable and raising the top frame of a drive to a fastening level between the side frames; and connecting the top frame to the side frames.
